(19) United States
(12) Patent Application Publication
(10) Pub. No.: US 2002/0129235 A1
(43) Pub. Date: Sep. 12, 2002

(54) Digital data distributing system

(76) Inventors: Ryuichi Okamoto, Studio City, CA (US); Masayuki Kozuka, Arcadia, CA (US); Mitsuhiro Inoue, Studio City, CA (US); Masataka Minami, Burbank, CA (US)

Correspondence Address: WENDEROTH, LIND & PONACK, L.L.P., 2033 K STREET N. W., SUITE 800, WASHINGTON, DC, 20006-1021, US

(21) Appl. No.: 09/757,578

(22) Filed: Jan. 11, 2001

(51) Int. Cl. G06F 17/60

(52) U.S. Cl. 713/150; 705/51; 380/231

(57) ABSTRACT

An object of the invention is to provide a system in which various services can be received by a plurality of receiving devices having different structures, without having to take into consideration the difference in the structures, by connecting an adapter that corresponds to the service the user wishes to receive. The distribution server 301 communicates with the storage media access adapter 303 via the receiving device 302, and thereby controls distribution of digital data.

### BACKGROUND OF THE INVENTION

1) Field of the Invention

The present invention relates to a digital data distribution system that enables the Electronic Commerce, in which digital data is sold for a fee via a network.

2) Description of the Related Art

In the Electronic Commerce that is conducted via a network, a consumer generally accesses a home page set up by an information provider. Then, the consumer selects digital data of his choice, goes through a purchasing process, and downloads the digital data. The digital data that has been downloaded undergoes a process for copyright protection such as encryption, in order to prevent illegal secondary distribution of the digital data that occurs through the network.

A conventional digital data distribution system will now be explained referring to FIG. 1.

Digital data to be distributed is stored encrypted in digital data storage means 105, which is stored in a distribution server 101 operated by the information provider. Its decryption key, the storage location of the encrypted digital data itself, and use condition information of the digital data are stored in a digital data administration database 104. The use condition information herein refers to, for instance, information indicating that the digital data can be copied to another storage media up to three times after it is downloaded.

The consumer operates a receiving device 102, and accesses the distribution server 101 via sending and receiving means 108 and communication means 109.

A distribution front end 106 sends to the receiving device 102 a list of music digital data to be distributed. The list of the music digital data is created based on data in the digital data administration database 104. The consumer browses the list information using browsing means 110. When the consumer finds digital data he wishes distributed to him, he sends a request for purchasing the digital data and his user name to the distribution server 101. If the distribution front end 106 does not find the user name in a user administration database 103, the distribution front end 106 sends to the browsing means 110 a request for payment information inputs such as credit card number. The consumer inputs the requested payment information via the browsing means 110, and sends the payment information to the distribution server 101. The distribution front end 106 records the payment information in the user administration database 103, and executes the payment process. If the user name is found in the user administration database 103, the payment process is executed using the payment information stored in the user administration database 103. Once the payment process is completed successfully, the distribution front end 106 directs the digital data distribution means 107 to send the digital data, of which the user requested distribution to the receiving device 102. The digital data distribution means 107 retrieves the designated digital data from the distribution digital data storage means 105, and the decryption key and use condition information for the digital data from the digital data administration database 104, and sends them to the receiving device 102. Digital data administration means 111 stores the digital data it received in digital data storage means 113. The digital data administration means 111 also stores the decryption key and the use condition information it received in secure information storage means 112. The secure information storage means 112 stores these data after encrypting them with information that relates to the receiving device 102.

When the user plays the digital data on the receiving device 102, the digital data administration means 111 reads the encrypted digital data from the storage media 113, and its decryption key from the secure information storage means 112, and decrypts the digital data.

When the digital data written in the storage media 114 is to be copied to another portable storage media 117, the digital data administration means 111 refers to the use condition information and copy history information that are stored in the secure information storage means 112. The copy history information indicates the number of copies that have been made in the past. In this manner, the digital data administration means 111 determines whether the digital data may be copied. If the digital data administration means 111 determines that the digital data may be copied, the media access process control means 114 receives the digital data and its decryption key from the digital data administration means 111, and copies them in the storage media 117 via the storage media access means 116. At this time, the decryption key is copied after being encrypted with a media ID 118, which is an ID unique to each storage media 117 and has been detected by the media ID detection means 115. Once the digital data is copied to the storage media 117, the digital data administration means 111 increments the copy history information by one. The copy history information is stored in the secure information storage means 112.

As described above, in the conventional technology, the distribution server uses only the user information in order to conduct digital data distribution control. On the other hand, the receiving device administers the decryption key of the digital data, the use right information of the digital data, and the use history information of the digital data with designated secure information storage means 112, which can not be accessed with a consumer's regular operation.

Such conventional digital data distribution system is always subject to possibilities of hacking activities by malicious consumers, such as illegal obtainment of the digital data from the distribution server 101 and illegal secondary distribution of the digital data that has been distributed to the receiving device 102. As a result, a portion that conducts administration of rights of digital data (the digital data administration means 111 and the secure information storage means 112) and the interface portion to the storage media (the media access process control means 114 and media ID detecting means 115), which copies digital data to a storage media in a safe manner are more or less equipped with a tamper-resistant technology.

However, the aforesaid conventional structure has following problems, because the equipment of the tamper-resistant technology within the receiving device is indispensable.

The tamper-resistant technology is closely related to the structure of a device to which the tamper-resistant technology is applied. Therefore, when there is a plurality of devices which have different structures, a tamper-resistant technology has to be developed for each device. This is a huge burden for manufacturers which develop and sale devices. Also, it is difficult for providers of digital data services to start new services if a tamper-resistant technology has to be developed for each receiving device every time a new service is started in order to let devices having different structures receive the service.

### SUMMARY OF THE INVENTION

The present invention has been conceived for the aforementioned situations. More specifically, the object of the present invention is to provide a system in which a plurality of devices having different structures can receive various services without taking into consideration the difference in the structure, by conducting administration of rights of digital data at a server, installing an interface portion to a storage media in an adapter that accesses the storage media, and connecting to an adapter that corresponds to the service to be received.

To achieve the aforementioned object, the digital data distribution system according to claim 1 of the present invention includes a distribution server that distributes digital data, a receiving device that receives the digital data sent from the distribution server, a storage media in which the digital data that the receiving device has received is written, and an adapter that writes in the storage media the digital data that the receiving device has received. The receiving device includes communication means for accessing the distribution server, browsing means for browsing and responding to information sent from the distribution server, and adapter connection control means for controlling connection with the adapter. The storage media includes a media ID, which is information specific to the storage media and cannot be tampered with, the media ID being able to uniquely identify the storage media. The adapter includes secure communication means, an adapter ID that uniquely identifies the adapter, adapter ID detecting means for extracting the adapter ID and sending the adapter ID to the distribution server, media ID detecting means for extracting the media ID from the storage media and sending the media ID to the distribution server, storage media access means for writing and reading data in and from the storage media, and media access process control means for controlling the writing and reading in and from the storage media by the storage media access means. The distribution server includes secure communication means, sending and receiving means for sending and receiving information and the digital data to and from the receiving device, a distribution front end for creating information to be sent to the user and processing accesses by the user, a user administration database that stores user IDs and account information of related users, a digital data administration database that stores storage location information and use conditions of digital data to be distributed, an obtained rights administration database that stores information regarding a right to receive distribution of digital data that each user has obtained, a history database that stores information regarding digital data that has been distributed to users in the past, an adapter administration database that stores adapter IDs of adapters that each user uses, a storage media administration database that stores media IDs of storage medias that each user uses, distribution digital data storage means for storing encrypted digital data and decryption keys for decrypting the encrypted digital data, key encryption means for encrypting the decryption key stored in the distribution digital data storage means, using the media ID sent from the media ID detecting means, and digital data distribution means for sending to the receiving device the encrypted digital data and the encrypted decryption key based on a direction from the distribution front end, the encrypted digital data being stored in the distribution digital data storage means, the decryption key being encrypted by the key encryption means. The secure communication means of the adapter and the secure communication means of the distribution server communicate with each other, thereby establishing a secure communication path between the adapter and the distribution server. The communication between each structural element within the adapter and each structural element within the distribution server is conducted through the secure communication path that has been established. The distribution front end authorizes a user based on the adapter ID sent from the adapter ID detecting means. The distribution front end determines whether the digital data with respect to which distribution is requested can be distributed, by referring to the obtained rights administration database, the history database, the digital data administration database, and the storage media administration database, in order to execute processes in response to a request for distribution of digital data from the authorized user.

The digital data distribution system according to claim 2 of the present invention includes a distribution server that distributes digital data, a receiving device that receives the digital data sent from the distribution server, a storage media in which the digital data that the receiving device has received is written, and an adapter that writes in the storage media the digital data that the receiving device has received. The receiving device includes communication means for accessing the distribution server, browsing means for browsing and responding to information sent from the distribution server, and adapter connection control means for controlling connection with the adapter. The storage media includes a media ID, which is information specific to the storage media that cannot be tampered with, the media ID being able to uniquely identify the storage media. The adapter includes secure communication means, an adapter ID that uniquely identifies the adapter, adapter ID detecting means for extracting the adapter ID and sending the adapter ID to the distribution server, media ID detecting means for extracting the media ID from the storage media and sending the media ID to the distribution server, key encryption means, storage media access means for writing and reading data in and from the storage media, media access process control means for controlling the writing and reading in and from the storage media by the storage media access means. The distribution server includes secure communication means, sending and receiving means for sending and receiving information and the digital data to and from the receiving device, a distribution front end for creating information to be sent to the user and processing accesses by the user, a user administration database that stores user IDs and account information of related users, a digital data administration database that stores storage location information and use conditions of digital data to be distributed, an obtained rights administration database that stores information regarding a right to receive distribution of digital data that each user has obtained, a history database that stores information regarding digital data that has been distributed to users in the past, an adapter administration database that stores adapter IDs of adapters that each user uses, a storage media administration database that stores media IDs of storage medias that each user uses, distribution digital data storage means for storing encrypted digital data and decryption keys for decrypting the encrypted digital data, and digital data distribution means for sending to the receiving device the encrypted digital data and the decryption key that are stored in the distribution digital data storage means based on a direction from the distribution front end. The key encryption means encrypts the decryption key using the media ID detected by the media ID detecting means, the decryption key being distributed by the digital data distribution means, the storage media access control means writing in the storage means the decryption key encrypted by the key encryption means by controlling the storage media access means. The secure communication means of the adapter and the secure communication means of the distribution server communicate with each other, thereby establishing a secure communication path between the adapter and the distribution server. The communication between each structural element within the adapter and each structural element within the distribution server is conducted through the secure communication path that has been established. The distribution front end authorizes a user based on the adapter ID sent from the adapter ID detecting means. The distribution front end determines whether the digital data with respect to which distribution is requested can be distributed by referring to the obtained rights administration database, the history database, the digital data administration database, and the storage media administration database, in order to execute processes in response to a request for distribution of digital data from the authorized user.

The digital data distribution system of claim 3 of the present invention includes a distribution server that distributes digital data, a receiving device that receives the digital data sent from the distribution server, a storage media in which the digital data that the receiving device has received is written, and an adapter that writes in the storage media the digital data that the receiving device has received. The receiving device includes communication means for accessing the distribution server, browsing means for browsing and responding to information sent from the distribution server, and adapter connection control means for controlling connection with the adapter. The storage media includes a media ID, which is information specific to the storage media and cannot be tampered with, the media ID being able to uniquely identify the storage media. The adapter includes secure communication means, an adapter ID that uniquely identifies the adapter, adapter ID detecting means for extracting the adapter ID and sending the adapter ID to the distribution server, media ID detecting means for extracting the media ID from the storage media and sending the media ID to the distribution server, encryption conversion means, key encryption means, storage media access means for writing and reading data in and from the storage media, and media access process control means for controlling the writing and reading in and from the storage media by the storage media access means. The distribution server includes secure communication means, sending and receiving means for sending and receiving information and the digital data to and from the receiving device, a distribution front end for creating information to be sent to the user and processing accesses by the user, a user administration database that stores user IDs and account information of related users, a digital data administration database that stores storage location information and use conditions of digital data to be distributed, an obtained rights administration database that stores information regarding a right to receive distribution of digital data that each user has obtained, a history database that stores information regarding digital data that has been distributed to users in the past, an adapter administration database that stores adapter IDs of adapters that each user uses, a storage media administration database that stores media IDs of storage medias that each user uses, distribution digital data storage means for storing digital data that is encrypted with a first encryption system and a decryption key that decrypts the digital data encrypted with the first encryption system, and digital data distribution means for sending to the receiving device the encrypted digital data and the decryption key that are stored in the distribution digital data storage means based on a direction from the distribution front end, the digital data being encrypted with the first encryption system. The encryption conversion means decrypts the digital data which is encrypted with the first encryption system and distributed by the digital data distribution means with the decryption key that has been distributed by the digital data distribution means, and encrypts the decrypted digital data with a second encryption system. The key encryption means encrypts the key that has been used when the encryption conversion means encrypted the digital data with the second encryption system, using the media ID detected by the media ID detecting means. The storage media access control means writes in the storage media the key encrypted by the key encryption means, by controlling the storage media access means. The secure communication means of the adapter and the secure communication means of the distribution server communicate with each other, thereby establishing a secure communication path between the adapter and the distribution server. The communication between each structural element within the adapter and each structural element within the distribution server is conducted through the secure communication path that has been established. The distribution front end authorizes a user based on the adapter ID sent from the adapter ID detecting means. The distribution front end determines whether the digital data with respect to which distribution is requested can be distributed, by referring to the obtained rights administration database, the history database, the digital data administration database, and storage media administration database, in order to execute processes the in response to a request for distribution of digital data from the authorized user.

According to a digital distribution control method of claim 4 of the present invention, in the digital distribution system as set forth in any of claims 1-3, the distribution front end authorizes a user based on the adapter ID sent from the adapter ID detecting means, and the distribution front end determines whether the digital data with respect to which distribution is requested can be distributed, by referring to the obtained rights administration database, the history database, the digital data administration database, and the storage media administration database, in response to a request for distribution of digital data from the authorized user, in order to execute processes.

The digital data distribution system of claim 5 of the present invention is the digital data distribution system as set forth in any of claims 1-3, wherein the adapter includes secure communication means updating means for updating the secure communication means of the adapter. The distribution server includes secure communication means updating means for updating the secure communication means of the distribution server, and secure communication means update direction means for directing the secure communication updating means within the adapter and the secure communication updating means within the distribution server to update the secure communication means.

### BRIEF DESCRIPTION OF THE DRAWINGS

FIG. 1 shows an example of a structure a digital data distribution system in accordance with the conventional technology.

FIG. 2 shows an example of application of a digital data distribution system in accordance with the first embodiment of the present invention.

FIG. 3 shows a structure of the digital data distribution system in accordance with the first embodiment of the present invention.

FIG. 4 shows a structure of a storage media in accordance with the first embodiment of the present invention.

FIG. 5 shows an example of a user account information database in accordance with the first embodiment of the present invention.

FIG. 6 shows an example of an adapter information database in accordance with the first embodiment of the present invention.

FIG. 7 shows an example of a storage media information database in accordance with the first embodiment of the present invention.

FIG. 8 shows an example of a service type database in accordance with the first embodiment of the present invention.

FIG. 9 shows an example of a digital data information database in accordance with the first embodiment of the present invention.

FIG. 10 shows an example of an obtained rights administration database in accordance with the first embodiment of the present invention.

FIG. 11 shows an example of a history database in accordance with the first embodiment of the present invention.

FIG. 12 is a flowchart of an overall operation of the digital data distribution system in accordance with the first embodiment of the present invention.

FIG. 13 is a flowchart explaining a joining process in accordance with the first embodiment of the present invention.

FIG. 14 is a flowchart explaining a digital data selection process in accordance with the first embodiment of the present invention.

FIG. 15 is a flowchart explaining a subscription handling process in accordance with the first embodiment of the present invention.

FIG. 16 is a flowchart explaining a single sale handling process in accordance with the first embodiment of the present invention.

FIG. 17 is a flowchart explaining a digital data download process in accordance with the first embodiment of the present invention.

FIG. 18 is a flowchart explaining a storage media legitimacy check process in accordance with the first embodiment of the present invention.

FIG. 19 is a flowchart explaining a storage media writing process in accordance with the first embodiment of the present invention.

FIG. 20 is a view of an example of a log-in screen that the receiving device in accordance with the first embodiment of the present invention displays to the user.

FIG. 21 is a view of an example of a user registration screen that the receiving device in accordance with the first embodiment of the present invention displays to the user.

FIG. 22 is a view of an example of a subscription service digital data selection screen that the receiving device in accordance with the first embodiment of the present invention displays to the user.

FIG. 23 is a view of an example of a single sale service digital data selection screen that the receiving device in accordance with the first embodiment of the present invention displays to the user.

FIG. 24 is a view of an example of a download digital data selection screen that the receiving device in accordance with the first embodiment of the present invention displays to the user.

FIG. 25 is a flowchart explaining a secure communication method updating process in accordance with the first embodiment of the present invention.

FIG. 26 shows a structure of the digital data distribution system in accordance with the second embodiment of the present invention.

FIG. 27 is a flowchart explaining a storage media writing process in accordance with the second embodiment of the present invention.

FIG. 28 shows a structure of the digital data distribution system in accordance with the third embodiment of the present invention.

FIG. 29 is a flowchart explaining a storage media writing process in accordance with the third embodiment of the present invention.

FIG. 30 shows an example of the digital data distribution system in accordance with the present invention.

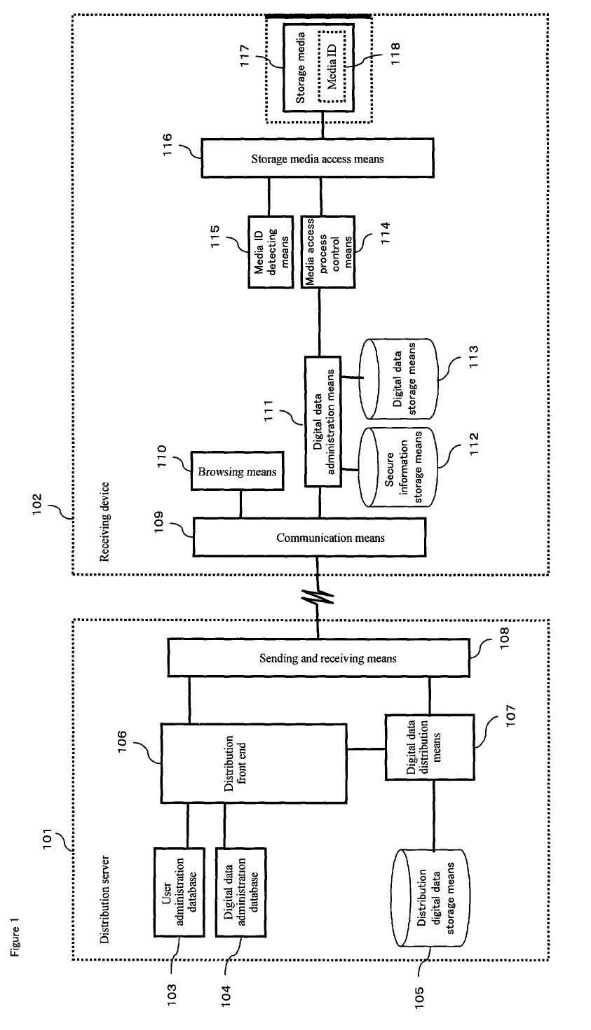

### DESCRIPTION OF THE PREFERRED EMBODIMENTS

### First Embodiment

A first embodiment of the present invention will now be explained referring to figures.

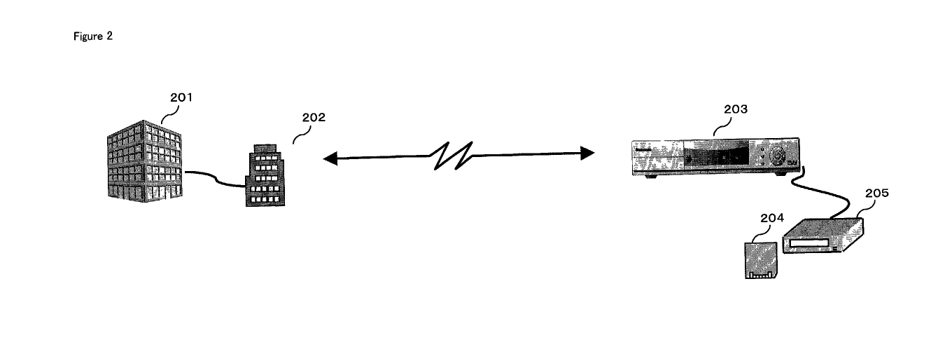

FIG. 2 is a view of an example of application of a digital data distribution system in accordance with the first embodiment of the present invention. 201 is a digital data distribution service firm which operates a distribution server for distributing digital data. 203 is a STB (Set Top Box) operated by a consumer. 202 is a Cable base station, which connects the digital data distribution service firm 201 and the receiving device 203 of the consumer via a Cable network. 204 is a storage media in which the distributed digital data in written. 205 is an access adapter that is connected to the receiving device 203, and writes in the storage media 204 the digital data that the receiving device 203 receives.

In this embodiment, a situation where the digital data is music digital data is discussed as an example. Also, services provided by the digital data distribution system include three services as examples: single sale service in which each song has a fixed price, a subscription service in which the consumer can freely download any desired songs from a designated group of music digital data up to a predetermined number upon paying a fixed monthly fee, and another subscription service in which the consumer can download any desired songs unlimitedly from a group of music digital data upon paying a fixed monthly fee.

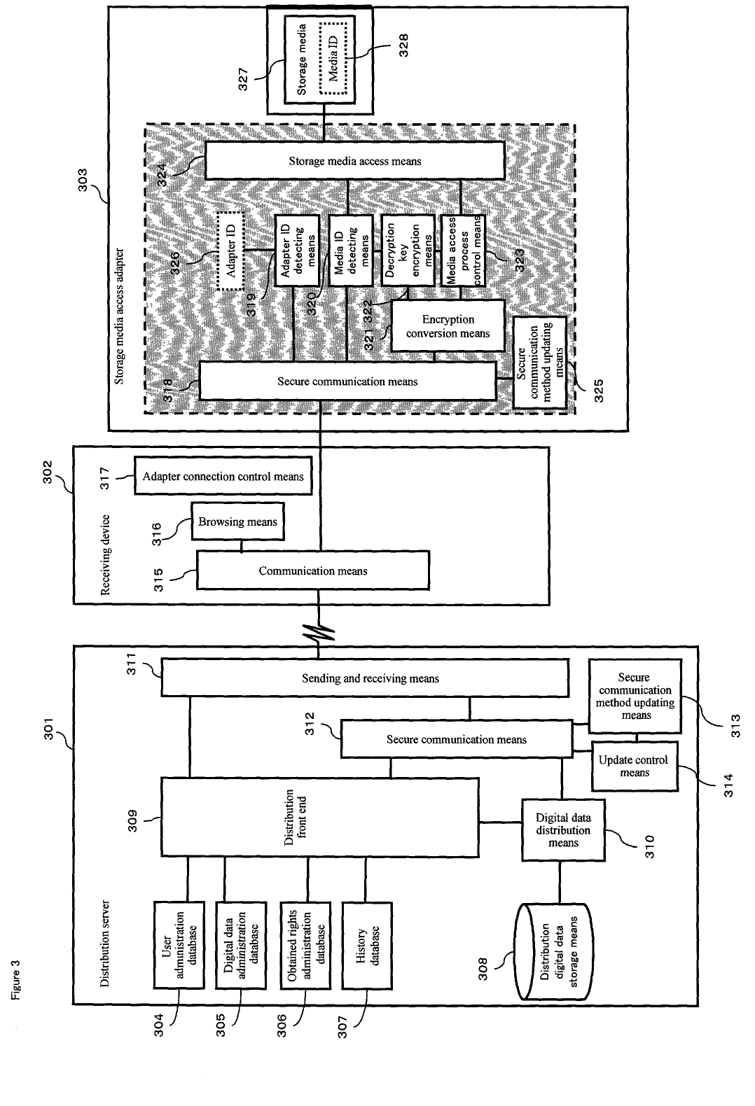

FIG. 3 is a view of a structure of a digital data distribution system in accordance with the present embodiment. The digital data distribution system of the present embodiment includes a distribution server 301, a receiving device 302, and a storage media access adapter 303.

The distribution server 301 is a server for distributing digital data. The distribution server 301 includes a user administration database 304, a digital data administration database 305, an obtained rights administration database 306, a history database 307, distributed digital data storage means 308, a distribution front end 309, digital data distribution means 310, sending and receiving means 311, secure communication means 312, secure communication method updating means 313 and update control means 314.

The receiving device 302 is a device that receives digital data. The receiving device 302 includes communication means 315, browsing means 316, and adapter connection control means 317.

The storage media access adapter 303 is an adapter that reads and writes data from and in a storage media 327. The storage media access adapter 303 has an adapter ID 326 which is an ID that uniquely identifies an adapter. The storage media access adapter 303 includes secure communication means 318, adapter ID detecting means 319, media ID detecting means 320, encryption conversion means 321, decryption key encryption means 322, media access process control means 323, storage media access means 324, and secure communication method updating means 325. In this embodiment, each of the structural elements in the storage media access adapter 303 is integrally installed within one LSI (a portion encircled by a broken line is FIG. 3).

Each structural element will now be explained below.

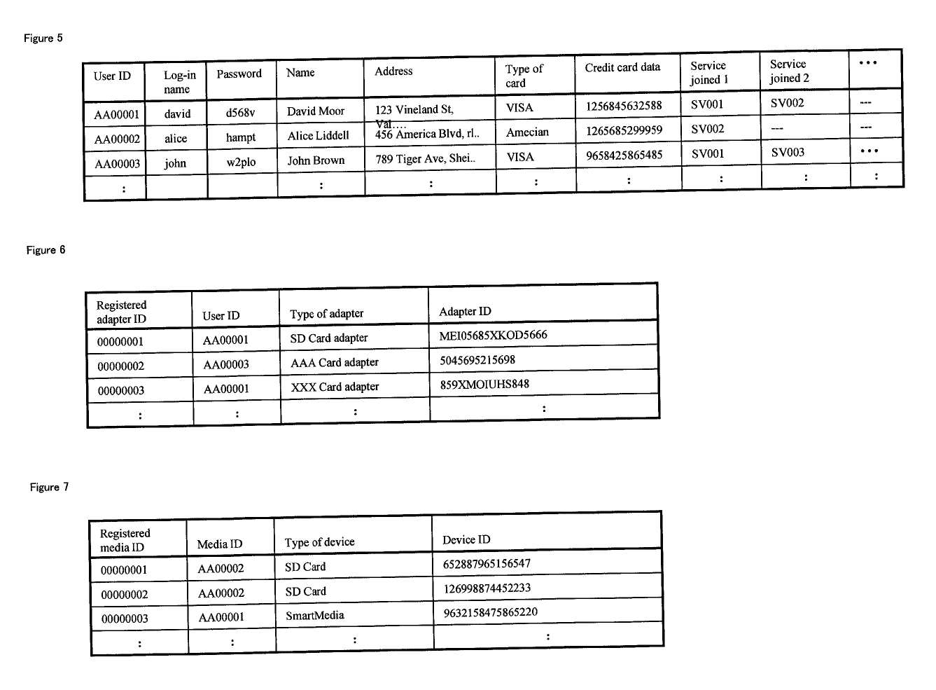

The user administration database 304 is a relational database that includes three databases: a user account information database that stores users' account information, an adapter information database that stores information regarding adapters that users own, and a storage media information database that stores information regarding storage medias that users have used as the distribution location in the past. FIG. 5 is a view of an example of the user account information database. The user account information database includes user ID, log-in name, password, user's name, user's address, the type of credit card with which payment is to be made, credit card number, and information regarding the music distribution service plan the user has joined. FIG. 6 is a view of an example of the adapter information database. The adapter information database includes an adapter registration ID, which is the index information of this database, user ID of the owner of the adapter, information regarding the type of the adapter, and adapter ID.

FIG. 7 is a view of an example of the storage media information database. The storage media information database includes media registration ID, which is index information of this database, user ID which has received distribution of digital data, information regarding type of media, and media ID.

The digital data administration database 305 includes a service type database which stores digital data vending service plans that are sold at the site, and a digital data information database that stores information regarding the digital data itself and information regarding the storage locations of the digital data.

FIG. 8 is a view of an example of the service type database. The service type database includes service ID that is the index information, service name, payment method type for the service, fee for the service, DL song number limit, which is information regarding the limit on the number of songs a user can download, and DL times limit, which is information regarding the limit on the number of times of download per song.

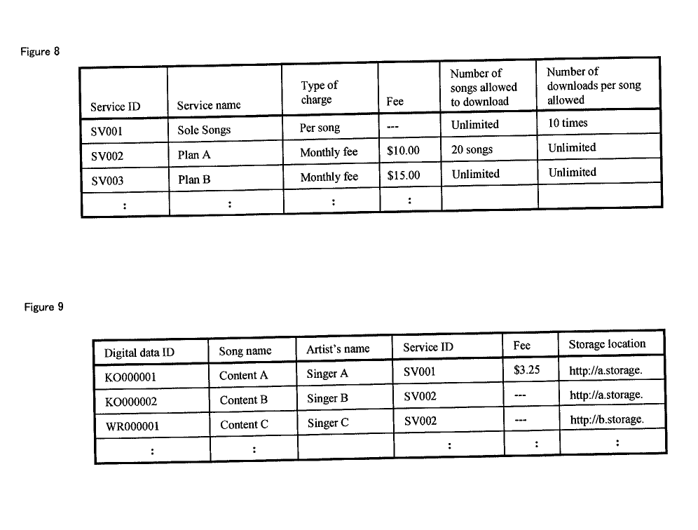

FIG. 9 is a view of an example of the digital data information database. The digital data information database includes digital data ID, name of digital data song, name of artist, service ID to which the digital data belongs, fee for the digital data, and storage location information of the digital data.

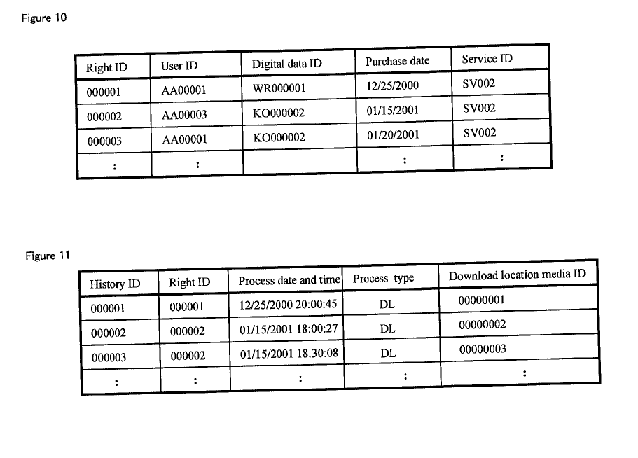

The obtained rights administration database 306 is a database that administers rights to have digital data distributed, that the users have obtained. FIG. 10 is a view of its example. The obtained rights administration database 306 includes right ID, which is the index, user ID which has obtained a right to have digital data distributed, digital data ID of the digital data, date of purchasing the right, and service ID to which the digital data belongs.

The history database 307 is a history database that administers information regarding distributions made to users. FIG. 11 is a view of its example. The history database 307 includes history ID, which is the index, pertinent right ID, date of the process, content of the process, and DL location media ID.

The distribution digital data storage means 308 stores the digital data to be distributed, after encrypting the digital data with a predetermined encryption system. The distributed digital data storage means 308 also stores the decryption key. Hereinafter, the encryption system employed herein is referred to as a first encryption system.

The distribution front end 309 creates homepage screen data of homepages to which the user accesses, and provides the homepage screen data to the user. The distribution front end 309 also executes processes of responding to operations that the user performs on the homepage screen data created by the distribution front end 309.

The digital data distribution means 310 executes a process of sending the encrypted digital data and the decryption key that are stored in the distribution digital data storage means 308 to the storage means access adapter 303.

The sending and receiving means 311 and the communication means 315 execute a communication process between the distribution server 301 and the receiving device 302. This communication process is executed securely using certain technologies such as SSL (Secure Socket Layer) as needed.

The secure communication means 312 and the secure communication means 318 communicate with each other, thereby establishing a secure communication path between the distribution server 301 and the storage media access adapter 303. Communication between each structural element within the distribution server 301 and each structural element within the storage media access adapter 303 is conducted through this secure communication path.

The secure communication method updating means 313 updates the secure communication means 312 according to a direction from the updating control means 314, which will be described later.

The updating control means 314 directs the secure communication method updating means 313 and the secure communication method updating means 325 to update the secure communication means 312 and the secure communication means 318 and change their method when, for instance, the method that has been utilized to establish the secure communication path between the secure communication means 312 and the secure communication means 318 is hacked.

The browsing means 316 displays the homepage screen data. The browsing means 316 also receives and processes operations that the user made on the homepage screen data.

The adapter connection control means 317 connects the receiving device 302 and the storage media access adapter 303, such that the distribution server 301 and the storage media access adapter 303 can communicate with each other via the receiving device 302.

The adapter ID detecting means 319 detects the adapter ID 326 that is included in the storage media access adapter 303, and sends the adapter ID 326 to the distribution server 301.

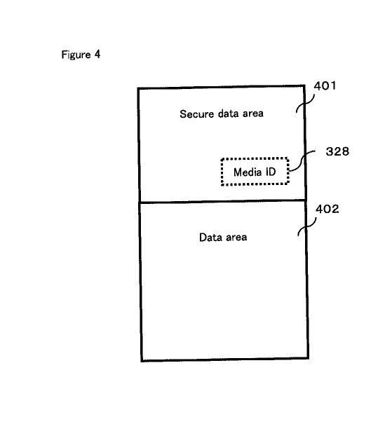

The media ID detecting means 320 obtains from the storage media 327 the media ID 328, which will be discussed later, and sends the media ID 328 to the distribution server 301. As shown in FIG. 4, the storage media 327 has a secure data area 401, which requires an authorization at the time of access, and a data area 402, which can be accessed without an authorization. The media ID 328, which can uniquely identify the storage media, is stored in the secure data area 401.

The encryption conversion means 321 decrypts digital data when it receives from the digital data distribution means 310 the digital data that has been encrypted with the first encryption system and its decryption key. Then, the encryption conversion means 321 encrypts the decrypted digital data using a predetermined encryption system. Hereinafter in this embodiment, the encryption system that is used herein is referred to as a second encryption system.

The decryption key encryption means 322 encrypts the key that the encryption conversion means 321 has utilized to encrypt the digital data with the second encryption system, by using the media ID 328 that has been detected by the media ID detecting means 320.

The media access control means 323 controls the storage media access means 324, which is a means to access the storage media 327. In this manner, writing and reading of data in and from the storage media 327 are controlled. The media access control means 323 controls the storage media access means 324, stores in the data region 402 the digital data that the encryption conversion means 321 has encrypted with the second encryption means, and stores in the secure data area 401 the key that the decryption key encryption means 322 has encrypted.

The secure communication method updating means 325 updates the secure communication means 318, according to a direction from the updating control means 314.

Operation of each element will now be explained below, with respect to each operation offered by the digital data distribution system.

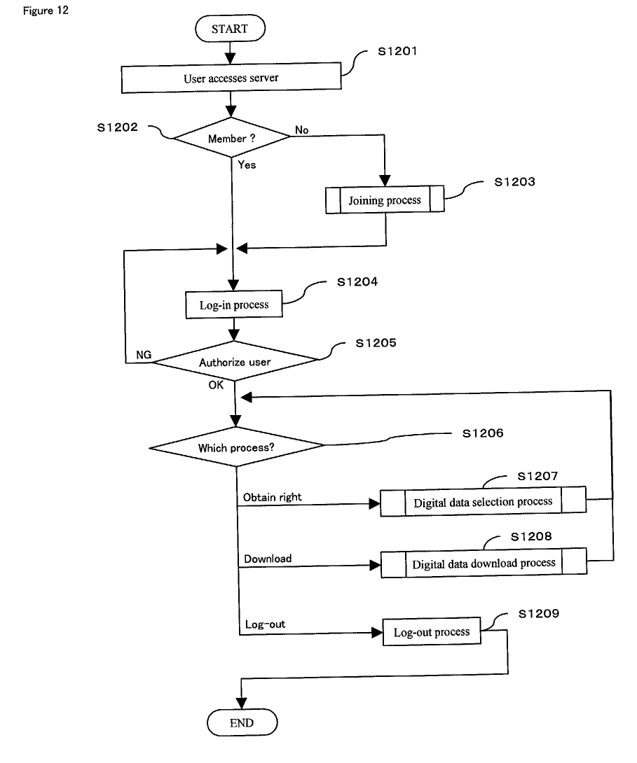

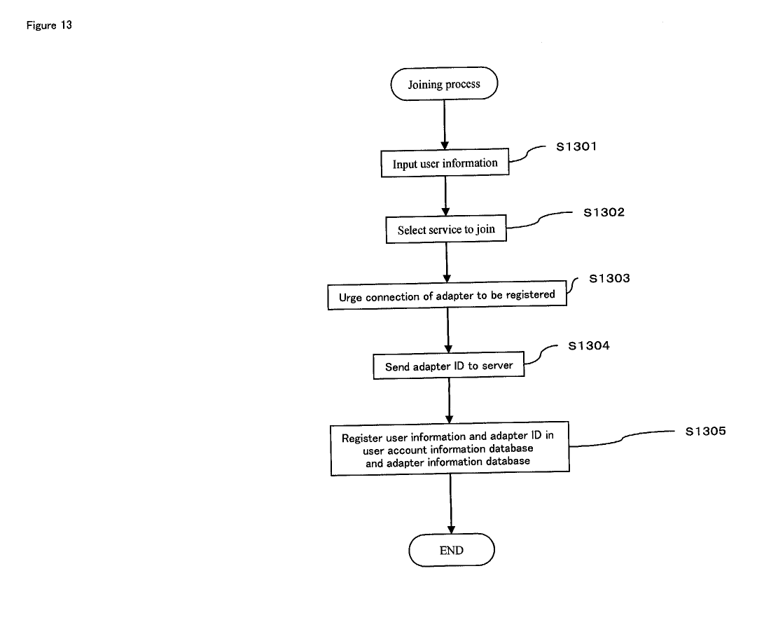

First of all, a flow of the overall operation of the digital data distribution system will be explained, referring to the flowchart in FIG. 12.

(S1201) The user accesses the distribution server 301, using the browsing means 316.

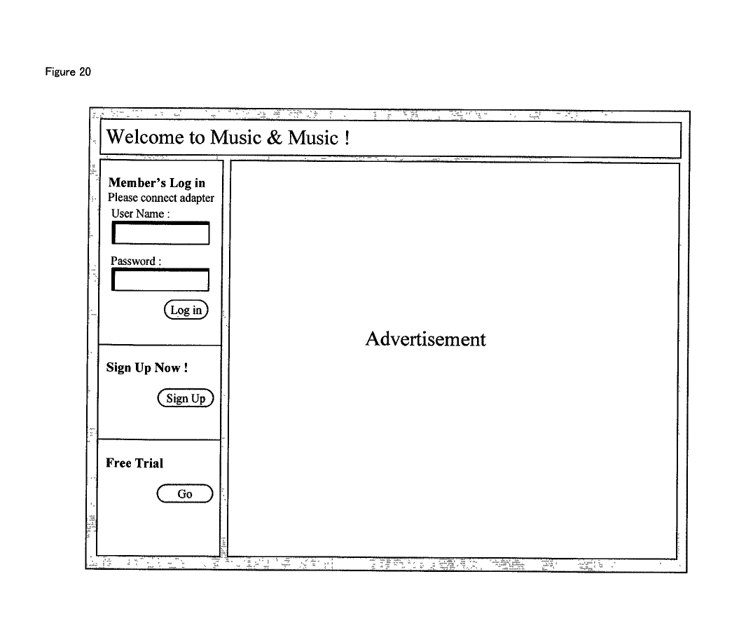

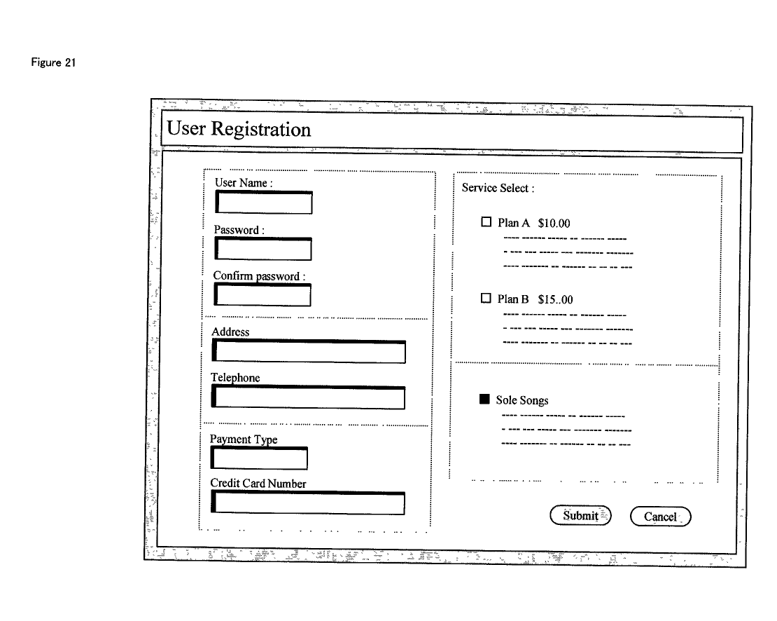

(S1202) The distribution front end 309 creates data for a log-in screen such as one shown in FIG. 20, and sends the log-in screen to the browsing means 316. The browsing means 316 displays the log-in screen.

(S1203) If the user is not a member of this service, a joining process, which will be described later, is executed.

(S1204) The user confirms that the storage media access adapter 303 is connected to the receiving device 302. If the storage media access adapter 303 is not connected, the user connects it. Then, the adapter connection control means 317 controls the connection status between the receiving device 302 and the storage media access adapter 303, such that the distribution server 301 and the storage media access adapter 303 can communicate with each other via the receiving device 302. Thereafter, the user inputs the user name and the password, and executes the Log-in button on the log-in screen displayed in S1202. Once the Log-in button is executed, the browsing means 316 sends the inputted user name and password to the distribution server 301. The adapter ID detecting means 319 detects the adapter ID 326, and sends the adapter ID 326 to the distribution server 301. This communication utilizes a secure communication path that is established by the secure communication means 312 and the secure communication means 318 through mutual communication. Hereinafter, communication between each structural element within the distribution server 301 and each structural element within the storage media access adapter 303 basically utilizes this secure communication path.

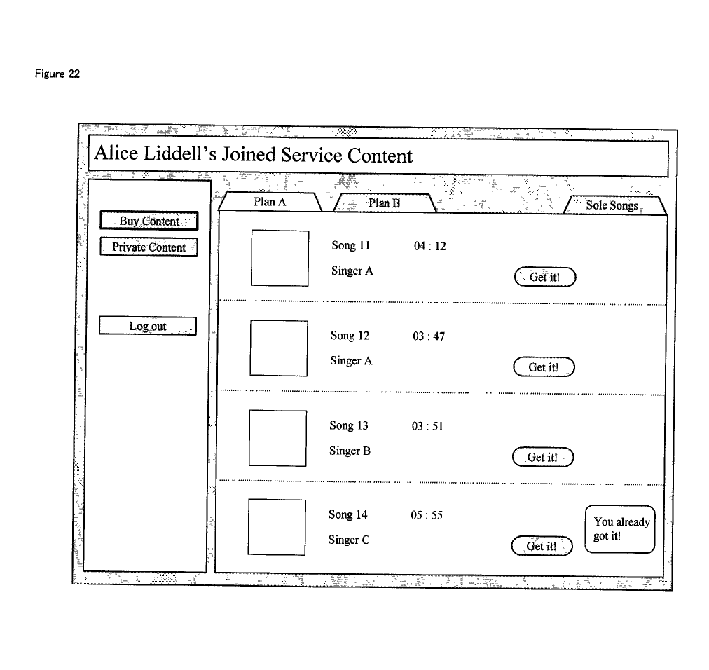

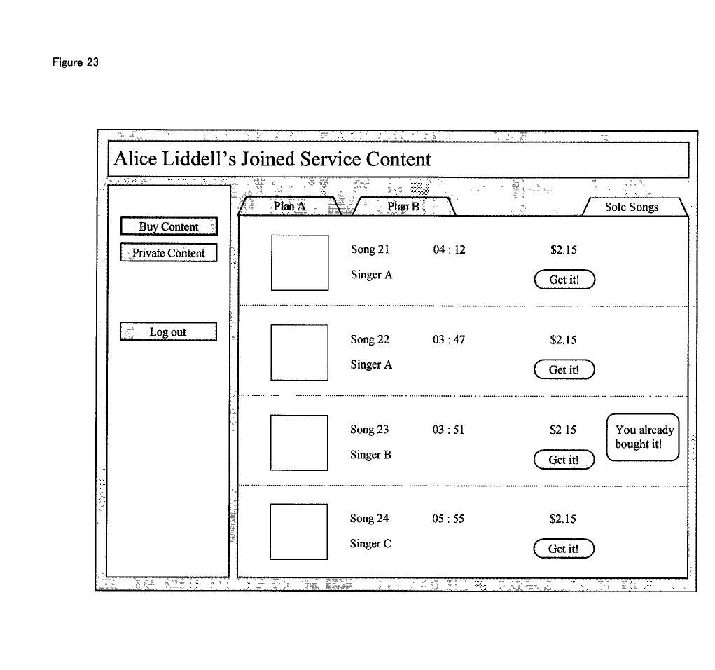

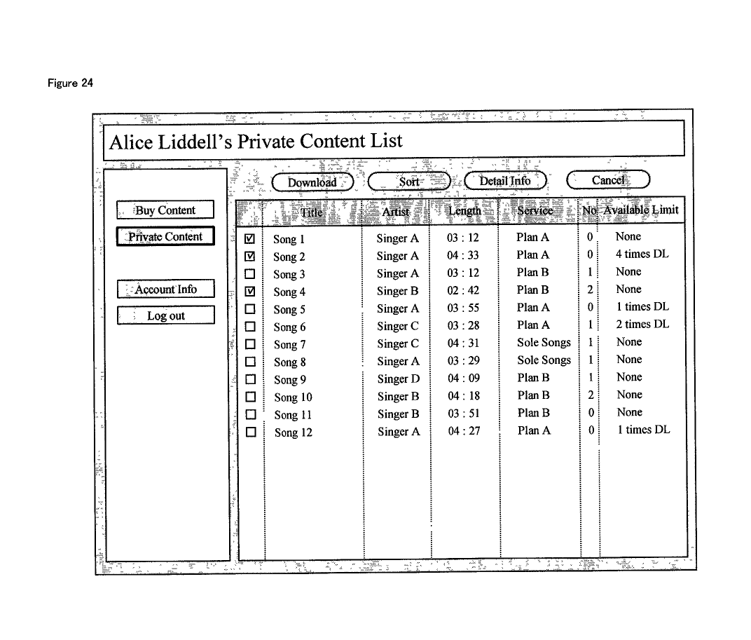

(S1205) The distribution front end 309 refers to the user administration database 304, and determines the user based on the user name, password, and the adapter ID 326 that have been sent in S1204. Then, the distribution front end 309 creates data for a selection screen such as one shown in FIG. 22, which is customized for the user identified above and allows the user to select a song to obtain right to download. Then, the distribution front end 309 sends the data to the receiving device 302. If the information that has been sent in S1204 is illegitimate, the distribution front end 309 creates data for a screen which notifies the user as such and urges the user to log-in again. Then, the screen data is sent to the receiving device 302.

(S1206) In a screen such as one shown in FIG. 22, the user utilizes the browsing means 316, and selects a process he wishes to execute from: obtainment of right to download digital data, downloading of digital data with respect to which the right to download has already been obtained, and log-out.

(S1207) If the user has selected obtainment of right to download digital data in S1206, a digital data selection process, which will be described later, is executed. Then, the system returns to S1206.

(S1208) If the user has selected in S1206 the downloading of digital data with respect to which the right to download has already been obtained, a digital data downloading process, which will be described later, is executed. Then, the system returns to S1206.

(S1209) If the user has selected log-out in S1206, the connection between the distribution server 301 and the receiving device 302 is disconnected, and this process ends.

The above concludes the explanation of the flow of the overall operation of the digital data distribution system.

FIG. 13 shows an operational flow of the joining process. The joining process is a process for conducting procedures to let a user become a member to receive a service. Its operation will be described below.

(S1301) The distribution front end 309 creates data for a user Aid registration screen such as one shown in FIG. 21, and sends the data to the receiving device 302. The browsing means 316 displays the user registration screen. The user then fills in required items, namely the user name, the password, the address, the phone number, and the credit card number to be used for payment.

(S1302) Next, the user selects the service he wishes to join. In the case of the single subscription service, the user does not need to go through the joining process at this point, since the user makes payment each time he purchases a song. The browsing means 316 sends the inputted information to the distribution server 301.

(S1303) Next, the distribution front end 309 creates a screen which urges the user to connect with the receiving device 302 the storage media access adapter 303 that will be utilized as a device for writing digital data in this service. Then, the distribution front end 309 sends the screen to the receiving device 302. The user connects with the receiving device 302 the storage media access adapter 303 that he wishes to use as a device for writing digital data.

(S1304) The adapter ID detecting means 319 detects the adapter ID 326, and sends the adapter ID 326 to the distribution server 301.

(S1305) The information sent in S1302 and S1304 is stored in the user account information database 304 by the distribution front end 309.

The above concludes the explanation of the joining process.

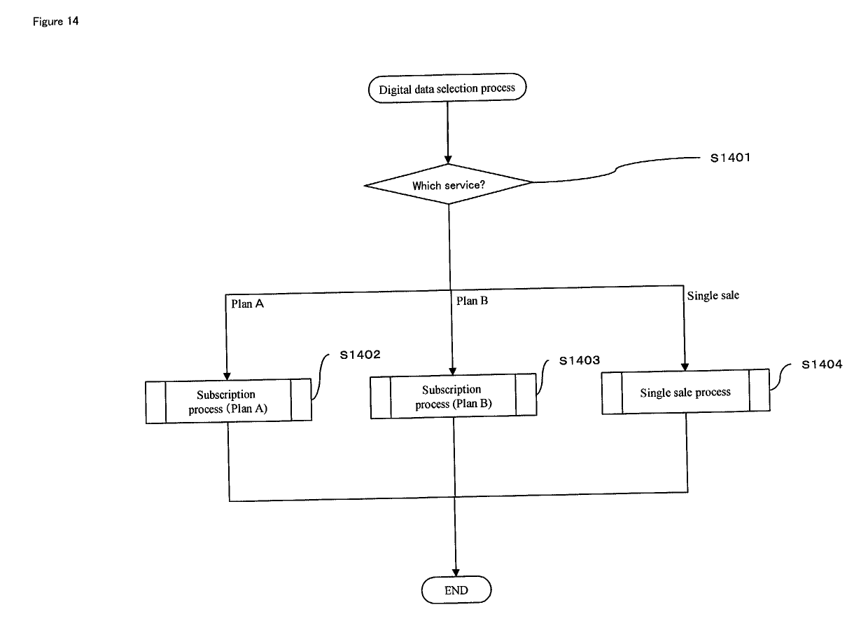

FIG. 14 shows an operational flow of the digital data selection process. The digital data selection process is a process by which a user obtains a right to download digital data. Its operation will be described below.

(S1401) The user selects the service he wishes to receive, using the browsing means 316.

(S1402-S1404) If the service that the user selected in S1401 is a subscription service, a subscription handling process, which will be described later, is executed. If the service that the user selected in S1401 is a single sale service, a single sale handling process, which will be described later, is executed.

This concludes the description of the digital data selection process.

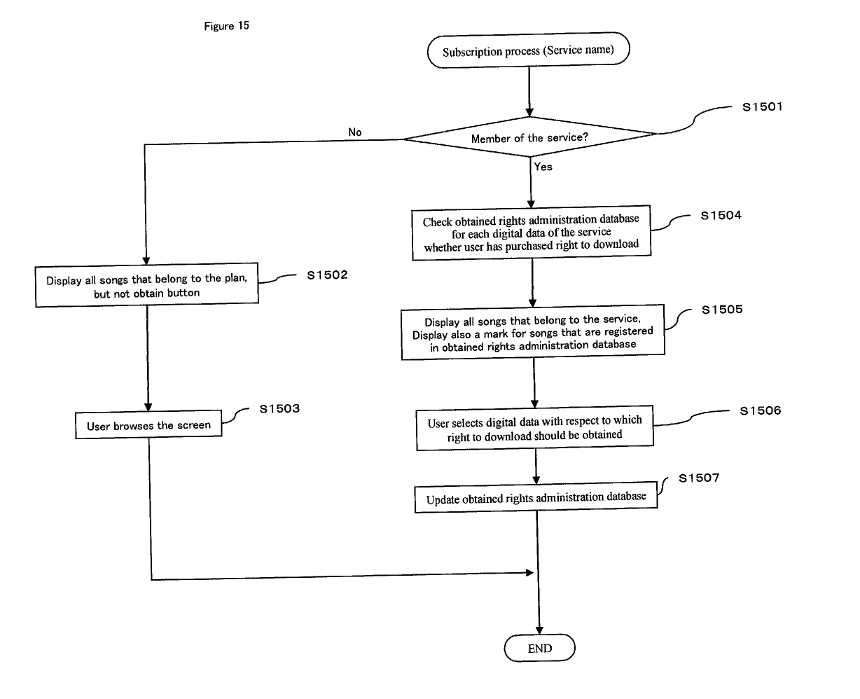

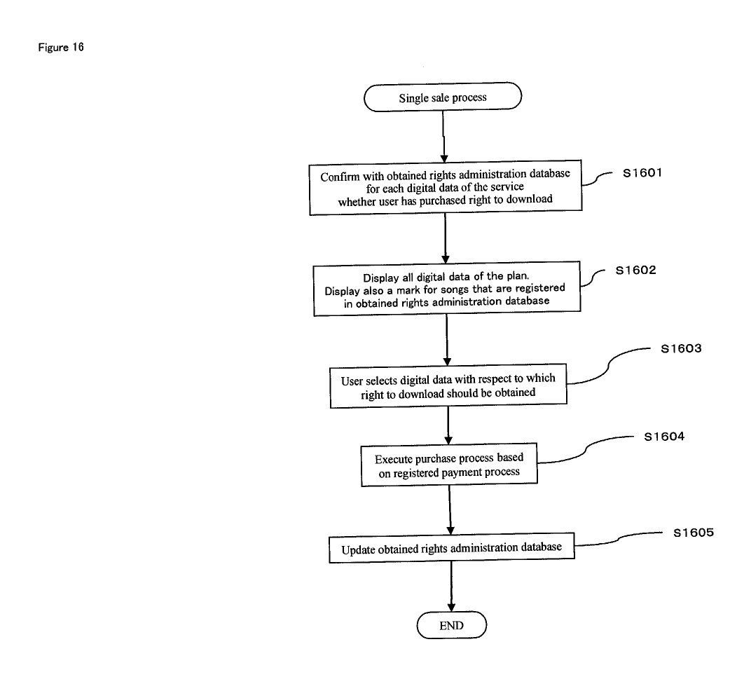

FIG. 15 shows an operational flow of the subscription handling process. The subscription handling process is a process in which a user obtains a right to download digital data which is distributed in the selected subscription service. Its operation will be described below.

(S1501) First of all, the distribution front end 309 refers to the user administration database 304, and verifies whether the user is a member of the subscription service that has been selected.

(S1502) If it is determined in S1501 that the user is not a member, the distribution front end 309 creates a screen that shows a list of digital data that belong to the selected service according to the digital data administration database 305, such that a selection of digital data can not be made. The screen is sent to the receiving device 302. The browsing means 316 displays the screen.

(S1503) In this case, the user can only browse the digital data list, using the browsing means 316.

(S1504) If it is determined in S1501 that the user is a member, the distribution front end 309 refers to the obtained rights administration database 306, and determines for each digital data that is included in the selected subscription service whether the user has already obtained the right to download.

(S1505) The distribution front end 309 displays a list of digital data that belong to the selected service according to the digital data administration database 305, such that the user can select digital data that belongs to the selected service. For the digital data with respect to which the right to download has already been obtained, the distribution front end 309 creates screen data in which these digital data bear a mark indicating that the right has already been obtained. The screen data is sent to the user device 302. The browsing means 316 displays the screen. An example of the screen is shown in FIG. 22.

(S1506) The user selects digital data that he wishes to obtain, using the browsing means 316. Then, the browsing means 316 sends the selected digital data to the distribution server 301.

(S1507) The distribution front end 309 newly registers in the obtained rights administration database 306, information regarding the digital data with respect to which the right to download has been requested, based on the information that has been sent out in S1506.

The above concludes the explanation of the subscription handling process.

FIG. 16 shows an operational flow of the single sale handling process. The single sale handling process is a process in which a user obtains the right to download digital data that is distributed in the single sale service. Its operation will be explained below.

(S1601) The distribution front end 309 refers to the obtained rights administration database 306, and determines for each of digital data that are included in the single sale service whether the user has obtained right to download.

(S1602) The distribution front end 309 displays a list of digital data that belong to the single sale service according to the digital data administration database 305, such that the user can make a selection. Furthermore, for the digital data with respect to which the user has obtained the right to download as determined in S1601, the distribution front end 309 creates screen data in which these digital data bear a mark indicating that the right has already been obtained. The screen data is sent to the receiving device 302. The browsing means 316 displays the screen. An example of the screen is shown in FIG. 23.

(S1603) The user selects the digital data that he wishes to obtain, using the browsing means 316. The browsing means 316 sends the selected digital data to the distribution server 301.

(S1604) The distribution front end 309 calculates the price of digital data with respect to which the user has requested right to download, referring to the digital data administration database 305. Then, a purchasing process is executed using the payment information such as credit card information registered in the user administration database 304.

(S1605) The distribution front end 309 newly registers in the obtained rights administration database 306 the information regarding the digital data for which the purchasing process has been executed.

The above concludes the explanation of the single sale handling process.

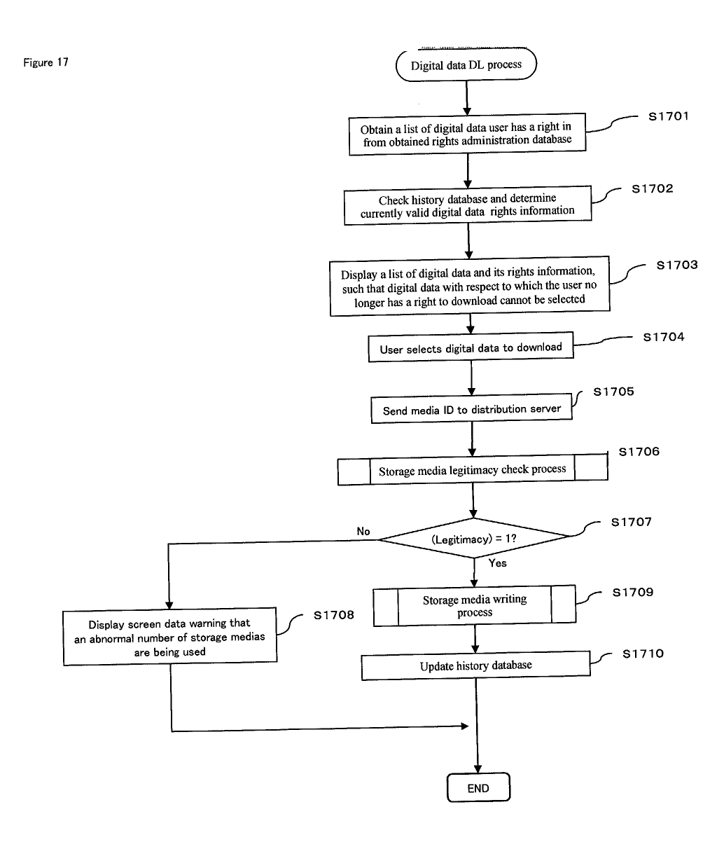

FIG. 17 shows an operational flow of the digital data download process. The digital data download process is a process in which the user downloads digital data. Its operation will be described below.

(S1701) First of all, the distribution front end 309 obtains from the obtained rights administration database 306 a list of digital data with respect to which the user has obtained the right to download.

(S1702) Next, the distribution front end 309 determines, for each of the digital data shown in the list that has been obtained in S1701, whether the digital data is available for downloading, and if it is, how many times more the digital data can be downloaded, by referring to the history database 307 and the digital data administration database 305.

(S1703) Then, the distribution front end 309 creates, based on the result in S1702, a screen data such as one shown in FIG. 24. The screen data shows a list of digital data with respect to which the user has the right to download, and the number of times the digital data can be downloaded. The screen data is sent to the receiving device 302. The browsing means 316 displays the screen.

(S1704) The user selects digital data he wishes to download, using the browsing means 316. The browsing means 316 sends the information to the distribution server 301.

(S1705) Next, the media ID detecting means 320 detects the media ID 328 of the storage media 327 currently connected to the storage media access adapter 303. Then, the media ID detecting means 320 sends the media ID 328 to the distribution server 301.

(S1706) The distribution front end 309 executes a storage media legitimacy check process, which will be described later, with respect to the storage media 327 having the media ID 328 that has been sent by the media ID detecting means 320 in S1705.

(S1707) The distribution front end 309 verifies the legitimacy of the storage media 327 having the media ID 328 that has been sent by the media ID detecting means 320 in S1705.

(S1708) If it is determined that the storage media 327 is not legitimate in S1707, the distribution front end 309 creates screen data that warns that the storage media may be illegitimate. The screen data is sent to the receiving device 302. The browsing means 316 displays the screen.

(S1709) If it is determined that the storage media 327 is legitimate in S1707, a storage media writing process, which will be described later, is executed.

(S1710) Lastly, the distribution front end 309 adds to the history database 307 the information that the digital data has been downloaded.

The above concludes the explanation of the digital data download process.

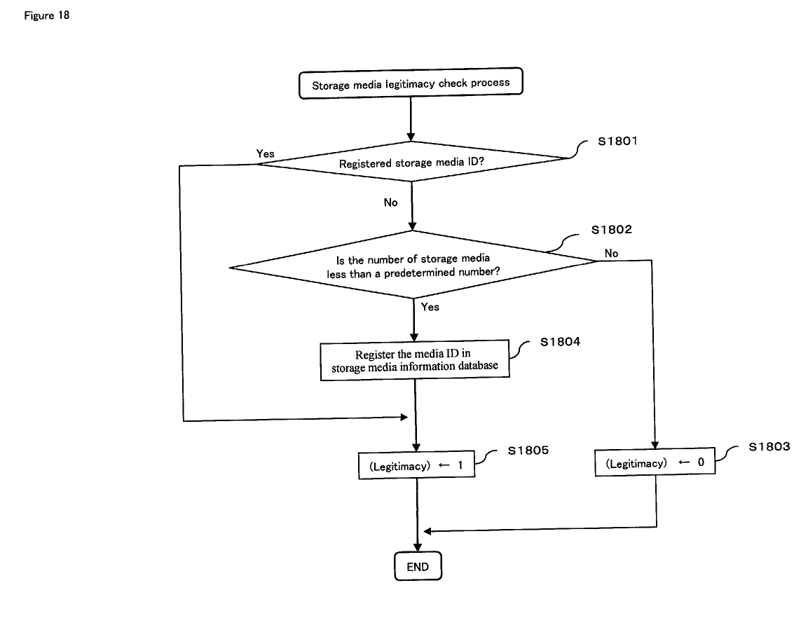

FIG. 18 shows an operational flow of the storage media legitimacy check process. The storage media legitimacy check process is a process in which a user checks the legitimacy of the storage media 327 in which the user is about to write the digital data. Its operation will now be explained.

(S1801) The distribution front end 309 verifies whether the media ID 328 that has been sent in S1705 is registered in the storage media registration database of the user administration database 304. If the distribution front end 309 determines that the media ID 328 is registered, the system proceeds to S1805.

(S1802) If it is determined in S1801 that the media ID 328 is not registered, the distribution front end 309 detects from the storage media information database of the user administration database 304 the number of storage medias 327 that the same user has used. Then, the distribution front end 309 determines whether the number of the storage medias 327 is greater than a predetermined number.

(S1803) If it is determined in S1802 that the number of the storage medias 327 is greater than the predetermined number, the distribution front end 309 determines that the storage media 327 being checked is not legitimate.

(S1804) If it is determined in S1802 that the number of the storage medias 327 is not greater than the predetermined number, the distribution front end 309 adds the media ID 328 that has been sent in S1705 in the storage media information database of the user administration database 304. The system proceeds to S1805.

(S1805) The distribution front end 309 determines that the storage media 327 being checked is legitimate.

This concludes the description of the storage media legitimacy check process.

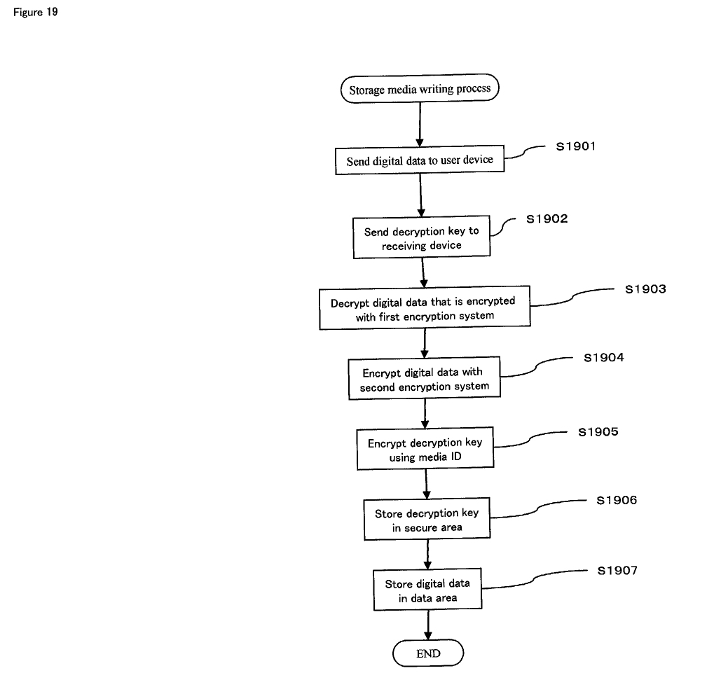

FIG. 19 shows an operational flow of the storage media writing process. The storage media writing process is a process in which digital data and its decryption key are written in the storage media 327. Its operation will now be explained.

(S1901) The digital data distribution means 310 sends to the storage media access adapter 303 the digital data which is stored in the distribution digital data storage means 308, and with respect to which a request for downloading has been made.

(S1902) The digital data distribution means 310 sends to the storage media access adapter 303 the decryption key for the digital data which is stored in the distribution digital data storage means 308, and with respect to which a request for downloading has been made.

(S1903) The encryption conversion means 321 decrypts the digital data that the digital data distribution means 310 has sent in S1901, using the decryption key that the digital data distribution means 310 has sent in S1902.

(S1904) The encryption conversion means 321 encrypts the digital data that the encryption conversion means 321 has decrypted in S1903, using the second encryption system.

(S1905) The decryption key encryption means 322 encrypts the key that was utilized when the encryption conversion means 321 encrypted the digital data in S1904, using the media ID 328 that the media ID detecting means 320 has detected.

(S1906) The media access process control means 323 stores the key that the decryption key encryption means 322 has encrypted in S1905 in the secure data area 401 of the storage media 327, by controlling the storage media access means 324.

(S1907) The media access process control means 323 stores the digital data that the encryption conversion means 321 has encrypted in S1904 in the data area 402 of the storage media 327, by controlling the storage media access means 324.

This concludes the explanation of the storage media writing process.

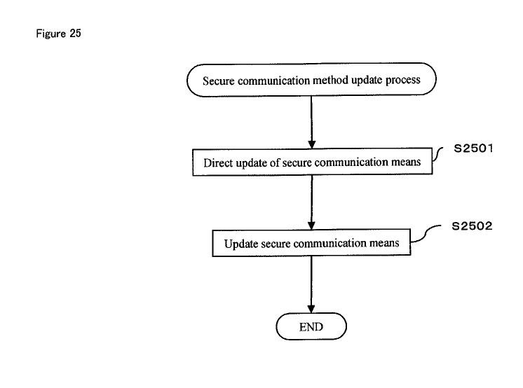

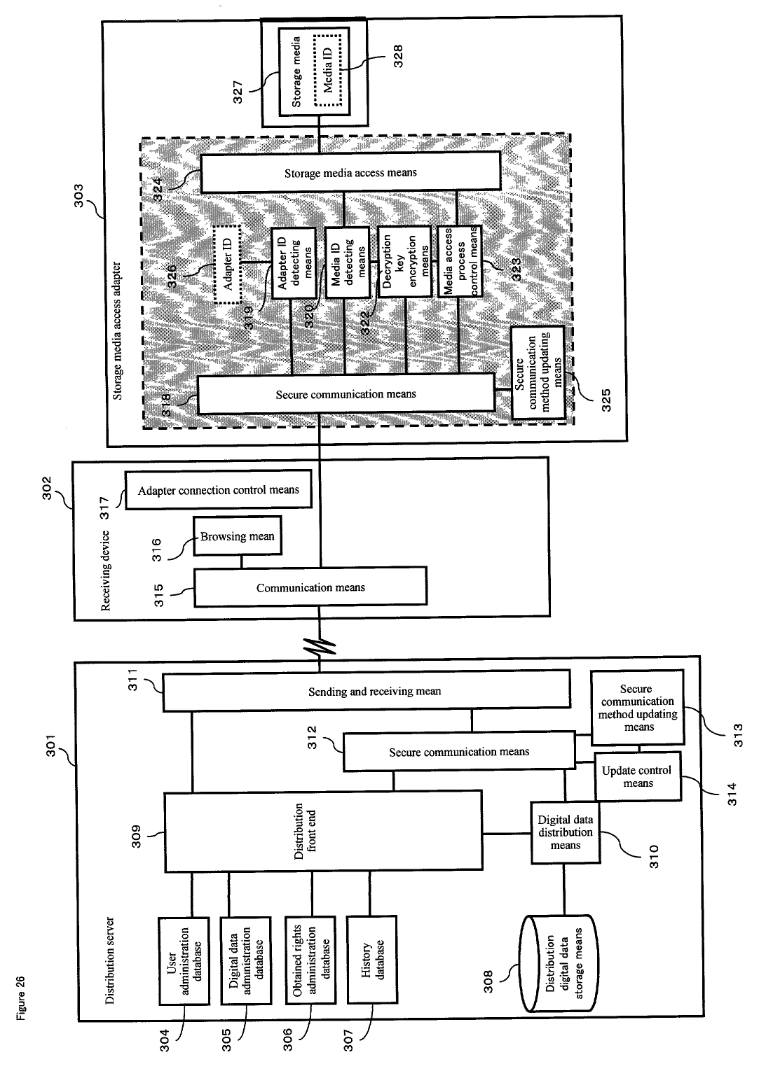

FIG. 25 shows an operational flow of the secure communication method updating process. The secure communication method updating process is a process in which the secure communication means 312 and the secure communication means 318 are updated in order to renew the method that has been utilized to establish a communication path between the secure communication means 312 and the secure communication means 318 when the method is hacked. Its operation will now be explained.

(S2501) The updating control means 314 directs the secure communication method updating means 313 to update the secure communication means 312. The updating means also directs the secure communication means updating means 325 to update the secure communication means 318. The direction for updating can be conducted by sending a predetermined command, or by sending a software for updating.

(S2502) The secure communication method updating means 313 updates the secure communication means 312. The secure communication method updating means 325 updates the secure communication means 318.

The above concludes the description of the secure communication method updating process.

This concludes the description of the digital data distribution system in accordance with the first embodiment of the present invention.

### Second Embodiment

The digital data distribution system in accordance with the second embodiment of the present invention will now be described below referring to figures.

The digital data distribution system of the second embodiment is substantially the same as the digital data distribution system of the first embodiment. Therefore, only differences between the first and second digital data distribution systems as described herein. In figures, identical elements are given the identical referential numerals.

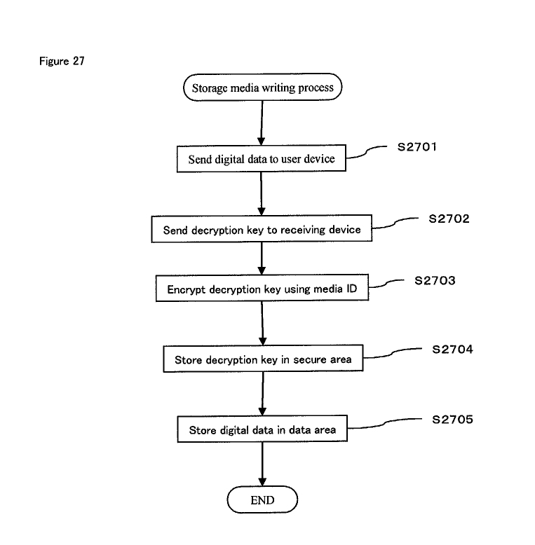

FIG. 26 is a view of the structure of the digital data distribution system in accordance with the second embodiment. The digital data distribution system of the second embodiment is different from that of the first embodiment in that there is no encryption conversion means 321 in the storage media access adapter 303. Also, the digital data distribution system is different in that the distribution digital data storage means 308 stores digital data that is encrypted with the second encryption system and its decryption key in advance. In the second embodiment, the digital data distribution means 310 sends the digital data encrypted with the second encryption system and its decryption key that are stored in the distribution digital data storage means 308 to the storage media access adapter 303. The decryption key encryption means 322 encrypts the decryption key that is sent from the digital data distribution means 310, using the media ID 328 detected by the media ID detecting means 320. The media access control means 323 writes in the storage media 327 the digital data that has been sent from the digital data distribution means 310 and encrypted with the second encryption system, and the decryption key that has been encrypted by the decryption key encryption means 322.

FIG. 27 shows an operational flow of the storage media writing process according to the second embodiment. Its operation will now be explained.

(S2701) The digital data distribution means 310 sends to the storage media access adapter 303 the digital data which is stored in the distribution digital data storage means 308, and with respect to which a request for downloading has been made.

(S2702) The digital data distribution means 310 sends to the storage media access adapter 303 the decryption key for the digital data, which is stored in the distribution digital data storage means 308, and with respect to which a request for downloading has been made.

(S2703) The decryption key encryption means 322 encrypts the decryption key that the digital data distribution means 310 has sent in S2702, using the media ID 328 that has been detected by the media ID detecting means 320.

(S2704) The media access process control means 323 stores the key that the decryption key encryption means 322 has encrypted in S2703 in the secure data area 401 of the storage media 327, by controlling the storage media access means 324.

(S2705) The media access process control means 323 stores the digital data that the digital data distribution means 310 has sent in S2701 in the data area 402 of the storage media 327, by controlling the storage media access means 324.

This concludes the explanation of the storage media writing process of the second embodiment. The processes other than the storage media writing process are the same as those in the first embodiment.

This concludes the description of the digital data distribution system of the second embodiment.

### Third Embodiment

The digital data distribution system in accordance with the third embodiment of the present invention will now be described below referring to figures.

The digital data distribution system of the third embodiment is substantially the same as the digital data distribution system of the second embodiment. Therefore, only differences between the third and second digital data distribution systems are described herein. In figures, identical elements are given the identical referential numerals.

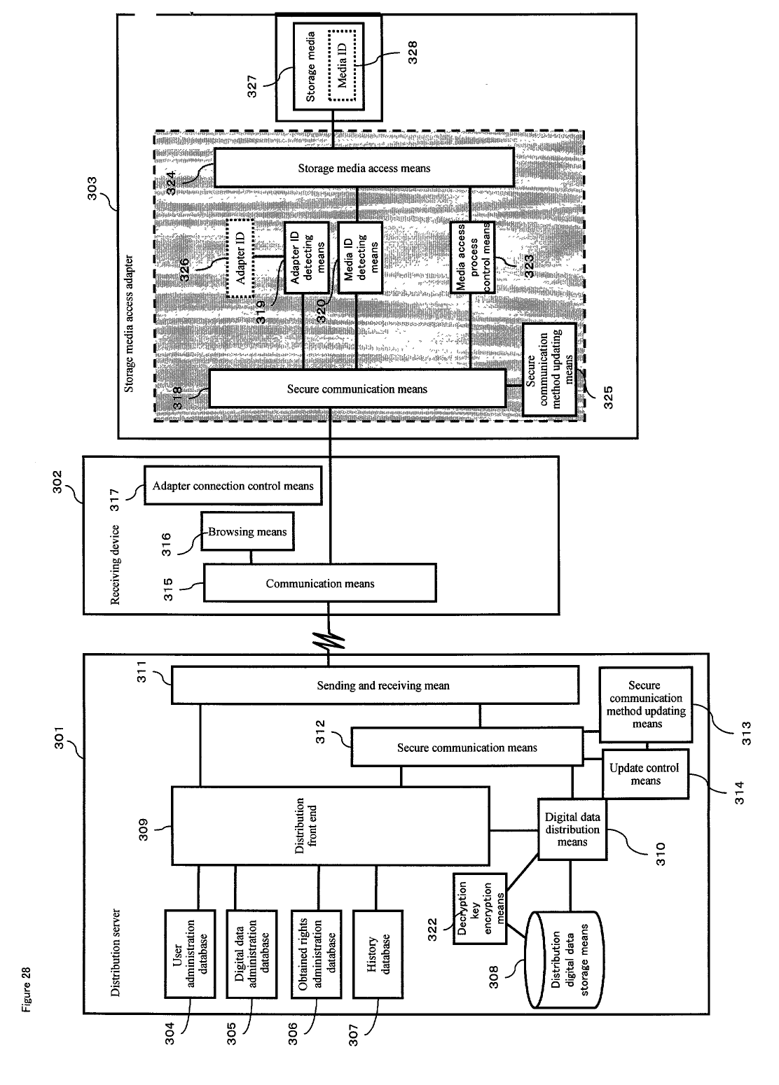

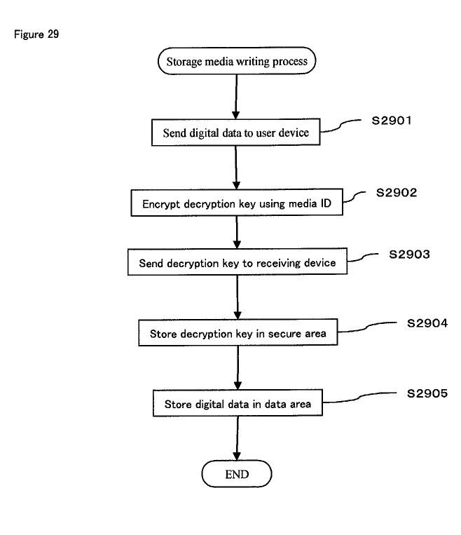

FIG. 28 is a view of the structure of the digital data distribution system in accordance with the third embodiment. The digital data distribution system of the third embodiment is different from that of the second embodiment in that the decryption key encryption means 322 is not in the storage media access adapter 303, but in the distribution server 301. As in the second embodiment, the distribution digital data storage means 308 has the digital data that is encrypted in advance with the second encryption system and its decryption key. In the third embodiment, the decryption key encryption means 322 encrypts the decryption key stored in the distribution digital data storage means 308, using the media ID 328 sent from the media ID detecting means 320. The digital data distribution means 310 sends to the storage media access adapter 303 the digital data encrypted with the second encryption system and its decryption key, which are stored in the distribution digital data storage means 308. The media access control means 323 writes in the storage media 327 the digital data that is encrypted with the second encryption system and the decryption key that is encrypted using the media ID 328, which digital data and decryption key are sent from the digital data distribution means 310, by controlling the storage media access means 324.

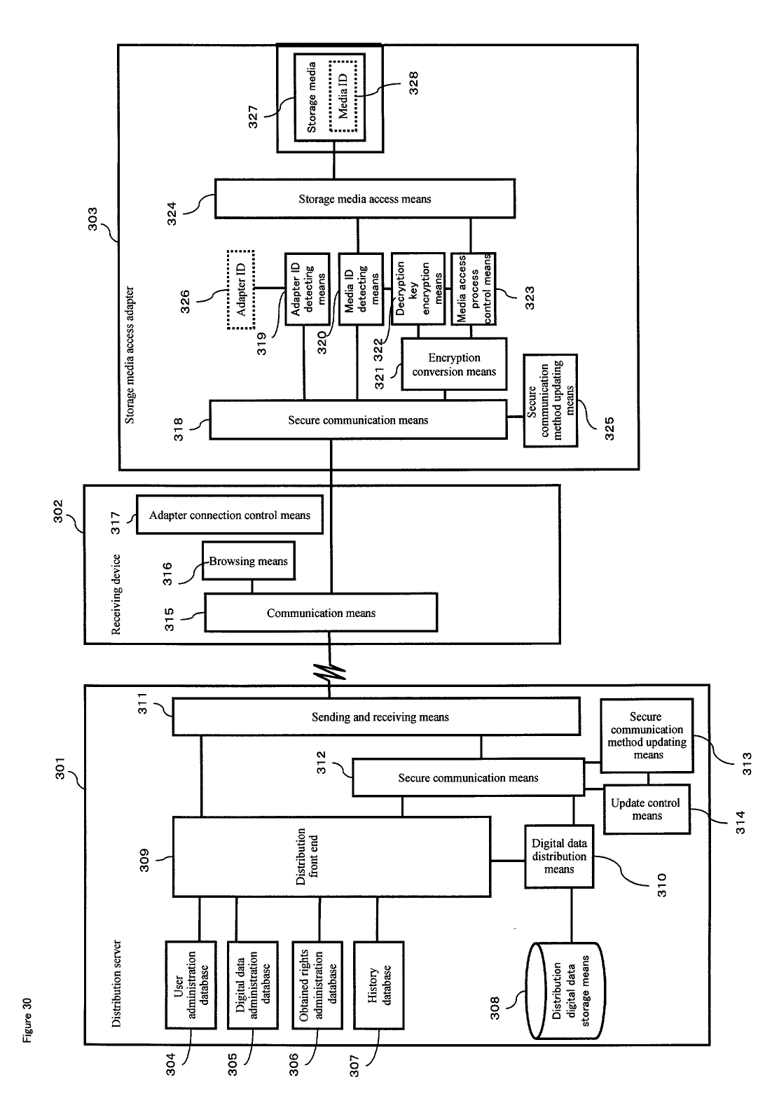

FIG. 29 shows an operational flow of the storage media writing process in accordance with the second embodiment. Its operation will now be explained.

(S2901) The digital data distribution means 310 sends to the storage media access adapter 303 the digital data which is stored in the distribution digital data storage means 308, and with respect to which a request for downloading has been made.

(S2902) The decryption key encryption means 322 encrypts the decryption key stored in the digital data storage means 308, using the media ID 328 sent from the media ID detecting means 320. The decryption key corresponds to the digital data with respect to which a request for downloading has been made.

(S2703) The digital data distribution means 310 sends the decryption key that the decryption key encryption means 322 has encrypted in S2902 to the storage media access adapter 303.

(S2904) The media access process control means 323 stores in the secure data area 401 of the storage media 327 the decryption key that the digital data distribution means 310 has sent in S2703, by controlling the storage media access means 324.

(S2705) The media access process control means 323 stores in the data area 402 of the storage media 327 the digital data that the digital data distribution means 310 has sent in S2701, by controlling the storage media access means 324.

This concludes the explanation of the storage media writing process of the third embodiment.

Although digital data is music data in the first through third embodiments, digital data can be other general electronic data, such as motion picture, static picture, digital books, and softwares.

Furthermore, although the services offered in the first through third embodiments are the subscription service which allows unlimited number of downloads, and the subscription service which has a predetermined limit on the number of downloads, other services that have different criteria can be offered, if the services can be offered based on information stored in the history database.

Furthermore, in the first through third embodiments, the screens displayed by the browsing means 316 are shown in figures. However, these screens are only an example. Actual screens may vary depending on presentation and design of the services.

Furthermore, in the first through third embodiments, the storage media 327 has the secure data area 401 and the non-secure data area 402. However, a storage media that does not have a secure data area 401 can also be used if the storage media has a media ID 328 that cannot be tampered with.

Furthermore, although the receiving device 302 is a STB in the first through third embodiments, the receiving device can also be a portable phone or a personal computer.

Furthermore, one of the information that authorizes the user is the user name and password in the first through third embodiments. However, it is not always necessary to use the user name and password. Other information such as the adapter ID 326 only, or a combination of the adapter ID 326 and other information may be utilized for authorization of the user.

Furthermore, although each structural element within the storage media access adapter 303 is installed in one LSI in the first through third embodiments, these elements do not necessarily need to be installed in one LSI, as shown in FIG. 30.

Furthermore, although the communication between the distribution server 301 and the receiving device 302 is conducted via the Cable in the first through third embodiments, other communication lines such as the Internet and the telephone line, and satellite communication may also be utilized. Additionally, different communication paths may be used for upstream and downstream lines, the downstream line being from the distribution server 301 to the receiving device 302, and the upstream line being from the receiving device 302 to the distribution server 301.

With the digital data distribution system described above, since the administration of right to digital data is conducted at the distribution server, and since the interface portion of the storage media is installed in an adapter that accesses the storage media, the consumer can receive various services by connecting the adapter that corresponds to each service to the receiving device that he owns. Furthermore, providers of digital data distribution services can start new services without having to take into consideration the difference between structures of receiving devices, even when there is a plurality of receiving devices having different structures. Furthermore, manufactures and dealers of receiving devices do not need to install tamper-resistant technology in the receiving devices. Accordingly, development of receiving devices becomes easy. Accordingly, the price of receiving devices can be lowered.

What is claimed is:

1. A digital data distribution system, comprising
a distribution server that distributes digital data;
a receiving device that receives the digital data sent from said distribution server;
a storage media in which the digital data that said receiving device has received is written; and
an adapter that writes in said storage media the digital data that said receiving device has received, wherein
said receiving device includes
communication means for accessing said distribution server,
browsing means for browsing and responding to information sent from said distribution server, and
adapter connection control means for controlling connection with said adapter,
said storage media includes a media ID, which is information specific to said storage media and cannot be tampered with, said media ID being able to uniquely identify said storage media,
said adapter includes
secure communication means,
an adapter ID that uniquely identifies said adapter,
adapter ID detecting means for extracting said adapter ID and sending said adapter ID to said distribution server,
media ID detecting means for extracting said media ID from said storage media and sending said media ID to said distribution server,
storage media access means for writing and reading data in and from said storage media, and
media access process control means for controlling the writing and reading in and from said storage media by said storage media access means,
said distribution server includes
secure communication means,
sending and receiving means for sending and receiving information and the digital data to and from said receiving device,
a distribution front end for creating information to be sent to the user and processing accesses by the user,
a user administration database that stores user IDs and account information of related users,
a digital data administration database that stores storage location information and use conditions of digital data to be distributed,
an obtained rights administration database that stores information regarding a right to receive distribution of digital data that each user has obtained,
a history database that stores information regarding digital data that has been distributed to users in the past,
an adapter administration database that stores adapter IDs of adapters that each user uses,
a storage media administration database that stores media IDs of storage medias that each user uses,
distribution digital data storage means for storing encrypted digital data and decryption keys for decrypting the encrypted digital data,
key encryption means for encrypting said decryption key stored in said distribution digital data storage means, using said media ID sent from said media ID detecting means, and
digital data distribution means for sending to said receiving device the encrypted digital data and the encrypted decryption key based on a direction from said distribution front end, the encrypted digital data being stored in said distribution digital data storage means, the decryption key being encrypted by said key encryption means,
said secure communication means of said adapter and said secure communication means of said distribution server communicate with each other, thereby establishing a secure communication path between said adapter and said distribution server,
the communication between each structural element within said adapter and each structural element within said distribution server is conducted through said secure communication path that has been established,
said distribution front end authorizes a user based on said adapter ID sent from said adapter ID detecting means, and
said distribution front end determines whether the digital data with respect to which distribution is requested can be distributed, by referring to said obtained rights administration database, said history database, said digital data administration database, and said storage media administration database, in order to execute processes in response to a request for distribution of digital data from the authorized user.

2. A digital data distribution system, comprising
a distribution server that distributes digital data;
a receiving device that receives the digital data sent from said distribution server;
a storage media in which the digital data that said receiving device has received is written; and
an adapter that writes in said storage media the digital data that said receiving device has received, wherein
said receiving device includes
communication means for accessing said distribution server,
browsing means for browsing and responding to information sent from said distribution server, and
adapter connection control means for controlling connection with said adapter,
said storage media includes a media ID, which is information specific to said storage media that cannot be tampered with, the media ID being able to uniquely identify said storage media,
said adapter includes
secure communication means,
an adapter ID that uniquely identifies said adapter,
adapter ID detecting means for extracting said adapter ID and sending said adapter ID to said distribution server,
media ID detecting means for extracting said media ID from said storage media and sending said media ID to said distribution server,
key encryption means,
storage media access means for writing and reading data in and from said storage media,
media access process control means for controlling the writing and reading in and from said storage media by said storage media access means,
said distribution server includes
secure communication means,
sending and receiving means for sending and receiving information and the digital data to and from said receiving device,
a distribution front end for creating information to be sent to the user and processing accesses by the user,
a user administration database that stores user IDs and account information of related users,
a digital data administration database that stores storage location information and use conditions of digital data to be distributed,
an obtained rights administration database that stores information regarding a right to receive distribution of digital data that each user has obtained,
a history database that stores information regarding digital data that has been distributed to users in the past,
an adapter administration database that stores adapter IDs of adapters that each user uses,
a storage media administration database that stores media IDs of storage medias that each user uses,
distribution digital data storage means for storing encrypted digital data and decryption keys for decrypting the encrypted digital data, and
digital data distribution means for sending to said receiving device the encrypted digital data and the decryption key that are stored in said distribution digital data storage means based on a direction from said distribution front end,
said key encryption means encrypts the decryption key using said media ID detected by said media ID detecting means, the decryption key being distributed by said digital data distribution means, said storage media access control means writing the decryption key encrypted by said key encryption means in said storage means by controlling said storage media access means,
said secure communication means of said adapter and said secure communication means of said distribution server communicate with each other, thereby establishing a secure communication path between said adapter and said distribution server,
the communication between each structural element within said adapter and each structural element within said distribution server is conducted through said secure communication path that has been established,
said distribution front end authorizes a user based on said adapter ID sent from said adapter ID detecting means, and
said distribution front end determines whether the digital data with respect to which distribution is requested can be distributed by referring to said obtained rights administration database, said history database, said digital data administration database, and said storage media administration database, in order to execute processes in response to a request for distribution of digital data from the authorized user.

3. A digital data distribution system, comprising
a distribution server that distributes digital data;
a receiving device that receives the digital data sent from said distribution server;
a storage media in which the digital data that said receiving device has received is written; and
an adapter that writes in said storage media the digital data that said receiving device has received, wherein
said receiving device includes
communication means for accessing said distribution server,
browsing means for browsing and responding to information sent from said distribution server, and
adapter connection control means for controlling connection with said adapter,
said storage media includes a media ID, which is information specific to said storage media and cannot be tampered with, the media ID being able to uniquely identify said storage media,
said adapter includes
secure communication means,
an adapter ID that uniquely identifies said adapter,
adapter ID detecting means for extracting said adapter ID and sending said adapter ID to said distribution server,
media ID detecting means for extracting said media ID from said storage media and sending said media ID to said distribution server,
encryption conversion means,
key encryption means,
storage media access means for writing and reading data in and from said storage media, and
media access process control means for controlling the writing and reading in and from said storage media by said storage media access means,
said distribution server includes
secure communication means,
sending and receiving means for sending and receiving information and the digital data to and from said receiving device,
a distribution front end for creating information to be sent to the user and processing accesses by the user,
a user administration database that stores user IDs and account information of related users,
a digital data administration database that stores storage location information and use conditions of digital data to be distributed,
an obtained rights administration database that stores information regarding a right to receive distribution of digital data that each user has obtained,
a history database that stores information regarding digital data that has been distributed to users in the past,
an adapter administration database that stores adapter IDs of adapters that each user uses,
a storage media administration database that stores media IDs of storage medias that each user uses,
distribution digital data storage means for storing digital data that is encrypted with a first encryption system, and a decryption key that decrypts the digital data encrypted with the first encryption system, and
digital data distribution means for sending to said receiving device the encrypted digital data and the decryption key that are stored in said distribution digital data storage means, based on a direction from said distribution front end, the digital data being encrypted with the first encryption system,
said encryption conversion means decrypts the digital data which is encrypted with the first encryption system and distributed by said digital data distribution means with the decryption key that has been distributed by said digital data distribution means, and encrypts the decrypted digital data with a second encryption system,
said key encryption means encrypts the key that has been used when said encryption conversion means encrypted the digital data with the second encryption system, using said media ID detected by said media ID detecting means,
said storage media access control means writes in said storage media the key encrypted by said key encryption means, by controlling said storage media access means,
said secure communication means of said adapter and said secure communication means of said distribution server communicate with each other, thereby establishing a secure communication path between said adapter and said distribution server,
the communication between each structural element within said adapter and each structural element within said distribution server is conducted through said secure communication path that has been established,
said distribution front end authorizes a user based on said adapter ID sent from said adapter ID detecting means, and
said distribution front end determines whether the digital data with respect to which distribution is requested can be distributed, by referring to said obtained rights administration database, said history database, said digital data administration database, and said storage media administration database, in order to execute processes in response to a request for distribution of digital data from the authorized user.

4. A digital distribution control method for controlling distribution of digital data, wherein
in said digital distribution system as set forth in any of claims 1-3,
said distribution front end authorizes a user based on said adapter ID sent from said adapter ID detecting means, and
said distribution front end determines whether the digital data with respect to which distribution is requested can be distributed, by referring to said obtained rights administration database, said history database, said digital data administration database, and said storage media administration database, in order to execute processes in response to a request for distribution of digital data from the authorized user.

5. The digital data distribution system as set forth in any of claims 1-3, wherein
said adapter includes secure communication means updating means for updating said secure communication means of said adapter, and
said distribution server includes
secure communication means updating means for updating said secure communication means of said distribution server, and
secure communication means update direction means for directing said secure communication updating means within said adapter and said secure communication updating means within said distribution server to update said secure communication means.
